(19) United States
(12) Patent Application Publication
(10) Pub. No.: US 2012/0315464 A1
(43) Pub. Date: Dec. 13, 2012

(54) LIGHTWEIGHT CEMENT BOARD

(75) Inventors: Olivier Refouvelet, Lyon (FR); Nicolas Pouteau, Lyon (FR)

(73) Assignee: LAFARGE, Paris (FR)

(21) Appl. No.: 13/579,116

(22) PCT Filed: Feb. 16, 2011
(86) PCT No.: PCT/FR2011/050330

§ 371 Date: Aug. 15, 2012

(30) Foreign Application Priority Data
Feb. 18, 2010 (FR) 1051157
Jul. 23, 2010 (FR) 1056079

(51) Int. Cl. C04B 24/16; B32B 13/02

(52) U.S. Cl. 428/317.9; 106/678

(57) ABSTRACT

A cement board has a density from 200 to 1000 kg/m³, the cement board produced from a foamed cement slurry including cement; water; from 0.01 to 5% of a water-reducing agent, a plasticizer or a superplasticizer, % by mass relative to the mass of cement; from 0.45 to 5%, of a foaming agent, % by mass relative to the mass of water; a water-soluble calcium salt; mineral particles from 0.1 to 300 μm in size; a ratio of foaming agent to calcium salt being from 0.3 to 0.8.

The present invention relates to a lightweight board of foamed cement.

Currently known cement boards, due to their mineral nature, have better mechanical performances compared to plaster boards. These cement boards may be produced by different processes and in particular by discontinuous processes (for example moulding, pressing, filtering, etc). The density of these boards is generally greater than 1. Due to their density, these boards are difficult to cut, which has consequences for the user. The user cannot cut these boards manually and has to use mechanical cutting means (for example jig saw, disc grinder, etc.), which reduces jobsite productivity and furthermore generates considerable amounts of dust, which may affect the health of the users. Additionally, due to their density, the screwing of the cement boards is more difficult for the installer than a standard plaster board and is less rapid. The drilling time is in fact longer and the quality of the screw tightening on the metal or wood framework is often mediocre.

Cement boards called lightweight due to the incorporation of lightweight fillers are also known. These lightweight fillers generally come from natural rocks or artificial rocks or are fillers coming from oil products, for example polystyrene beads. The disadvantage of using natural rocks is the shortage of suitable deposit resources. The disadvantage of using artificial rocks is their negative impact in primary energy also called grey energy, which increases the production costs of the boards. The disadvantage of using fillers from oil products is their impact on the environment in addition to the economic aspect related to variations of the price of oil.

The technical state of the art also describes plaster boards. However, these boards do not completely keep their intrinsic performances in the presence of humidity and/or water. It is indeed possible to limit the loss of intrinsic performances of traditional plaster board but it is not possible to completely preserve them. The traditional plaster board therefore does not always present the desired durability in these conditions.

Consequently, it has become necessary to find a new board which palliates the disadvantages of the known boards.

Therefore, the problem the invention aims to solve is to provide a new cement board which can be produced by a continuous process, for example on a production line of boards.

Unexpectedly, the inventors have shown that it is possible to lighten a cement slurry to produce boards of foamed cement by a continuous process.

With this aim the present invention provides a cement board having a density of 200 to 1000 kg/m³ characterised in that it is produced from a foamed cement slurry.

The invention also provides a process for production of a board according to the invention.

Finally, the invention relates to the use of a board according to the invention, characterised in that the board is used either as an element under tiling, as a cladding element of building shells, as a roof underlay element or as an element of dry construction.

The invention offers at least one of the advantages described below.

Advantageously, the cement board according to the invention has a specific gravity less than 1, whilst maintaining the mechanical strength necessary for handling the boards and contributing to the functional performance of the structures in which it is incorporated, under constraints of water and/or humidity.

The invention offers another advantage in that the cement board according to the invention has substantial dimensional stability, even when moisture variations occur, in particular variations of temperature and/or humidity. The size of the cement board according to the invention does not vary or varies only slightly and the dimensional stability results obtained are comparable to those of known plaster boards.

Another advantage of the present invention is that these boards according to the invention allow for manual cutting as for a known plaster board (for example with a saw, a cutter, etc.) as opposed to mechanical cutting. Advantageously, this cutting produces less dust compared to known cement boards.

Advantageously, the cement board according to the invention makes it possible to make a board adapted to dry construction.

Furthermore, the cement board according to the invention has the advantage of being universal, that is to say that it may be used just as well as an element under tiling (bathroom, work top, kitchen, shower, floor, etc.) as a cladding element of building shells, as a roof underlay element (ceilings under roofing, roof support boards, etc.), as an element for dry constructions (ceiling, partition wall, inner partitions, etc.) or as any type of board.

Finally, the production of cement boards according to the invention makes it possible to use a continuous forming process, followed by drying, for example in open air.

Advantageously, the environmental footprint of the cement board according to the invention is reduced compared to known cement boards.

Other advantages and characteristics of the invention will clearly appear after reading the following description and examples provided purely for illustrative and non-limiting purposes.

The expression <<hydraulic binder>>, is to be understood according to the present invention as any compound which has the property of becoming hydrated in the presence of water and the hydration of which makes it possible to obtain a solid having mechanical characteristics. The hydraulic binder according to the invention may in particular be a cement. Preferably, the hydraulic binder according to the invention is a Portland cement according to the EN 197-1 Standard.

The expression <<hydraulic composition>>, is to be understood according to the present invention as a mix of at least one hydraulic binder, with water, optionally aggregates, optionally admixtures according to the EN 934-2 Standard. The expression <<hydraulic composition>>, according to the invention denotes without distinction a composition in the fresh or hardened state. The hydraulic composition according to the invention may be a cement slurry or a mortar. Preferably, the hydraulic composition according to the invention is a cement slurry.

The term <<setting>>, is to be understood according to the present invention as the passage of the hydraulic binder to the solid state by hydration reaction. The setting is generally followed by a hardening period.

The expression <<dry construction>>, is to be understood according to the present invention as a construction method to make structures using industrialised components assembled on the jobsite.

First of all the invention relates to a cement board having a density from 200 to 1000 kg/m³ characterised in that it is produced from a foamed cement slurry comprising at least
cement;
water;
from 0.01 to 5% of a water-reducing agent, a plasticizer or a superplasticizer, % by mass relative to the mass of cement;
from 0.45 to 5%, of a foaming agent, % by mass relative to the mass of water;
a water-soluble calcium salt;
mineral particles from 0.1 to 300 μm in size; the ratio of foaming agent to calcium salt being from 0.3 to 0.8.

The suitable cements for the cement slurry used to produce the board according to the invention are Portland cement, the cements described according to the EN 197-1 Standard, cements of the calcium sulfoaluminate type, magnesium cements or the sulfoaluminate cements and mixtures thereof.

The calcium aluminate based cements, for example the aluminate cements or the Ciments Fondus® are also suitable according to the invention as well as cements according to the NF EN 14647 Standard.

The preferred magnesium cements comprise magnesium carbonates, magnesium oxides or magnesium silicates, for example as disclosed in U.S. Pat. No. 4,838,941.

The preferred cement according to the invention is Portland cement, either alone or in combination with other aforementioned cements, for example the sulfoaluminate cements. The most suitable Portland cement according to the invention is the one described according to the EN 197-1 Standard.

The ratio of cement (expressed as raw clinker) to the mineral particles of the foamed cement slurry used to produce the board according to the invention is preferably from 30/70 to 50/50, more preferably 35/65 to 50/50, most preferably approximately 35/65.

The water/cement ratio (expressed as raw clinker) of the foamed cement slurry used to produce the board according to the invention is preferably from 0.3 to 0.9, more preferably from 0.4 to 0.7, most preferably approximately 0.45. This water/cement ratio may vary, for example due to the water demand of the mineral particles used. This water/cement ratio is defined as being the mass ratio of the amount of water (W) to the mass of cement (C) (expressed as raw clinker).

Preferably, the cement slurry used to produce the board according to the invention comprises a water-reducing agent, a plasticizer or a superplasticizer. A water-reducing agent makes it possible to reduce by approximately 10 to 15% by mass the quantity of mixing water for a given workability time. By way of example, water-reducers include lignosulphonates, hydroxycarboxylic acids, carbohydrates, and other specific organic compounds, for example glycerol, polyvinyl alcohol, sodium alumino-methyl siliconate, sulfanilic acid and casein (refer to the Concrete Admixtures Handbook, Properties Science and Technology, V.S. Ramachandran, Noyes Publications, 1984).

Superplasticizers belong to the new class of water-reducers and are capable of reducing by approximately 30% by mass the amount of mixing water for a given workability time. By way of example of a superplasticizer, the PCP type of superplasticizers without an anti-foaming agent may be noted. The term <<PCP>> or <<polycarboxylate polyoxide>> is further to be understood according to the present invention as a copolymer of acrylic acids or methacrylic acids, and of their poly(ethylene oxide) (PEO) esters.

Preferably, the cement slurry used to produce the board according to the invention comprises 0.01 to 0.2%, more preferably 0.02 to 0.08% of a water-reducing agent, a plasticizer or a superplasticizer, % by mass relative to the mass of cement.

When the water-reducing agent, plasticizer or superplasticizer is used in solution, the quantity is given in active matter in the solution.

According to a variant of the invention, the cement slurry used to produce the cement board according to the invention does not comprise an anti-foaming agent, or any agent having the property to destabilize an air emulsion in a liquid. Certain commercial superplasticizers may contain anti-foaming agents and consequently these superplasticizers are not suitable for the cement slurry used to produce the board according to the invention.

Preferably, the cement slurry used to produce the board according to the invention comprises an anionic foaming agent.

Preferably, the cement slurry used to produce the board according to the invention comprises a foaming agent. Preferably this foaming agent is selected from an alkyl sulfonate, an alkyl ether sulfonate, a hydroxyalkyl ether sulfonate, an alpha olefin sulfonate, an alkyl benzene sulfonate, an alkyl sulphate, an alkyl ether sulphate, a hydroxyalkyl ether sulphate, an alpha olefin sulphate and an alkyl benzene sulphate, or mixtures thereof.

Preferably, the cement slurry used to produce the cement board according to the invention comprises an alkyl sulphate or an alkyl ether sulphate with linear or branched carbon chains of formula (I)

CₙH₂ₙ₊₁—(OCH₂CH₂)ₘ—OSO₃M (I)

in which n is from 8 to 14 and m is from 0 to 15, M being an alkali metal cation. M preferably represents a sodium ion or potassium, preferably a sodium ion; m is preferably from 0 to 10, for example from 0 to 9.

Preferably, the cement slurry used to produce the cement board according to the invention comprises a linear or branched alkyl ether sulphate of formula CₙH₂ₙ₊₁—(OCH₂CH₂)ₘ—OSO₃M in which n is from 8 to 12, preferably from 10 to 12, for example from 9 to 11, and m is from 1 to 6.

The radical CₙH₂ₙ₊₁ is preferably linear.

According to a variant of the invention, the cement slurry used to produce the cement board according to the invention comprises a mixture of alkyl ether sulphate and alkyl sulphate. Each alkyl ether sulphate and alkyl sulphate may themselves be a mixture of compounds of formula (I).

Preferably, the cement slurry used to produce the cement board according to the invention comprises a water-soluble calcium salt. This calcium salt may be selected from calcium chloride, calcium nitrite, calcium nitrate, calcium formate and calcium acetate, or mixtures thereof. Preferably, the water-soluble calcium salts are calcium chloride, calcium nitrite or calcium nitrate.

The water-soluble calcium salt may be in solid form, for example a powder, or in liquid form, for example an aqueous solution.

The expression <<water-soluble calcium salt>>, is to be understood according to the present invention as a salt having a solubility in water at 20° C. greater than 2 g/100 mL. Such salts generally have an anion which is compatible with cement slurries at the concentrations used in the invention.

The water-soluble calcium salt may be in a hydrated or anhydrous form: when a hydrate is used, the quantity is expressed as anhydrous material.

The ratio of foaming agent to water-soluble calcium salt is calculated on the basis of anhydrous calcium chloride as calcium salt. When a different calcium salt is used the mass of calcium salt used to calculate the ratio is the mass expressed in equivalent terms of the mass of anhydrous calcium chloride.

The ratio of foaming agent to water-soluble calcium salt is preferably from 0.4 to 0.8, for example from 0.45 to 0.75, more preferably from 0.45 to 0.65, very preferably from 0.45 to 0.6, most preferably from 0.45 to 0.55.

The cement slurry used to produce the cement board according to the invention comprises mineral particles. The preferred mineral particles according to the invention are calcium carbonate, silica fume, slags, fly ash, pozzolans, preferably pozzolans of natural origin, limestone or siliceous fillers, or mixtures thereof.

The size of the mineral particles is preferably from 1 to 100 μm, for example from 1 to 80 μm. The D₁₀ of the mineral particles is preferably from 1 to 4 μm. The D₅₀ of the mineral particles is preferably from 4 to 20 more preferably from 6 to 15 μm. The D₉₀ of the mineral particles is preferably from 12 to 100 μm.

Preferably, the cement board according to the invention has a density of 400 to 950 kg/m³, more preferably from 500 to 850 kg/m³, most preferably from 650 to 800 kg/m³.

Preferably, the cement slurry used to produce the cement board according to the invention further comprises a foam-stabilizing agent, for example a betaine, an amine oxide or a fatty amide.

Other additives may also be used, for example a retarder such as citric acid.

According to another variant of the invention, the cement slurry used to produce the cement board does not comprise lightweight aggregates as described according to the EN 206-1 Standard, for example perlite.

According to another variant of the invention, the cement slurry used to produce the cement board does not comprise lightweight fillers, for example polystyrene beads.

According to a variant, the cement slurry used to produce the cement board according to the invention further comprises hydrated, hemihydrated or anhydrous calcium sulphate.

According to a variant, the cement slurry used to produce the cement board according to the invention further comprises lime.

Preferably, the cement board according to the invention further comprises at least one facing. Advantageously, the cement board according to the invention may have on one of its sides, or preferably on each of its sides a woven or non-woven facing, for example of glass fibres, associated or not associated with a wall. These facings may or may not comprise fibres bound to each other by a binder.

Preferably, the cement board according to the invention further comprises at least one linking layer between the facing and the body of the board.

Process

The invention also relates to a process for production of a cement board according to the invention characterised in that it comprises at least
a step of putting into contact between at least
   cement;
   water;
   from 0.01 to 5% of a water-reducing agent, a plasticizer or a superplasticizer, % by mass relative to the mass of cement;
   from 0.45 to 5%, of a foaming agent, % by mass relative to the mass of water;
   a water-soluble calcium salt;
   mineral particles from 0.1 to 300 μm in size;

the ratio of foaming agent to calcium salt being from 0.3 to 0.8;
a step of introducing gas or foam;
a step of forming the board.

Another process used to produce at least one cement board according to the invention may comprise the following steps: mix a composition intended to form the body of the board with water, deposit this mix on a running support, which is entrained continuously by a running belt system, give its shape to the board using a roller, dry and cut the obtained board to the desired length, the composition intended to form the body of the board comprising at least
cement;
water;
from 0.01 to 5% of a water-reducing agent, a plasticizer or a superplasticizer, % by mass relative to the mass of cement;
from 0.45 to 5%, of a foaming agent, % by mass relative to the mass of water;
a water-soluble calcium salt;
   mineral particles from 0.1 to 300 μm in size;
   a gas or foam

the ratio of foaming agent to water-soluble calcium salt being from 0.3 to 0.8.

Another process making it possible to produce at least one cement board according to the invention may comprise the following steps:
a) mix a composition intended to from the body of the board with water;
b) add a foaming agent;
c) inject a gas into the slurry obtained in step b) and mix;
d) give a form to the foamed slurry
e) dry and cut the obtained pre-form.

Preferably, all the air introduced in the form of gas or in the form of foam is present in the cement board according to the invention.

The gas introduced in the process of production according to the invention may preferably be air.

The step of introducing the gas may be carried out in different ways, and in particular by either direct introduction of gas or by introduction of a dispersion of a gas phase in a liquid (foam).

The foam, which may be introduced, preferably comprises water, air and at least one foaming agent. This foaming agent may be anionic or non-anionic. It may be identical or different to the one used to produce the foamed cement slurry.

According to a first variant of the process according to the invention, the introduction of gas may be carried out by direct introduction of air. In particular, the process of direct injection of air described in the WO 2005/080294 application is most particularly suitable.

According to this first variant, the air is introduced under pressure, in particular the pressure is between 1 and 5 bars.

According to a second variant of the process according to the invention, the introduction of gas may be carried out by dispersion of a gas phase in a liquid, in particular by introduction of an air-in-water foam. The air-in-water dispersion may be introduced directly into the cement slurry, then mixed in a static or dynamic mixer, in the batch mode or continuous mode.

According to a variant the process of production of a board according to the invention further comprises a supplementary step of supplying at least one facing.

According to another variant the process of production of cement boards according to the invention comprises the following steps:
a) supplying at least a first facing by mechanical means;
b) preparing a first foamed cement slurry;
c) spreading the slurry obtained in step b) on the first facing as a first binding layer;
d) preparing a second foamed cement slurry;
e) spreading the second slurry obtained in step d) on the binding layer obtained in step c) as a core layer;
f) supplying a second facing by mechanical means;
g) preparing a third foamed cement slurry;
h) spreading the third slurry obtained in step g) on the second facing as a second binding layer;
i) Placing the second facing obtained in step h) on the core layer of the pre-form obtained in step e);
j) applying pressure on the pre-form.

According to another variant the process of production of cement boards according to the invention comprises the following steps:
a) supplying at least a first facing;
b) preparing a first paste of plaster;
c) spreading the paste obtained in step b) on the first facing as a first binding layer;
d) preparing a foamed cement slurry;
e) spreading the slurry obtained in step d) on the binding layer obtained in step c) as a core layer;
f) supplying a second facing;
g) preparing a second paste of plaster;
h) spreading the second paste obtained in step g) on the second facing as a second binding layer;
i) placing the second facing obtained in step h) on the core layer of the pre-form obtained in step e);
j) applying pressure on the pre-form.

According to another variant the process of production of cement boards according to the invention comprises the following steps:
a) supplying at least one first facing;
b) preparing a paste of foamed cement;
c) spreading the paste obtained in step b) on the facing as a core layer;
d) supplying a second facing;
e) applying pressure on the pre-form.

The process according to the invention has the advantage of being able to be carried out continuously, thanks to the cement slurry described above having high initial workability, limited setting time and rapid hardening allowing immediate handling of the boards at the end of the setting phase. The process according to the invention consequently makes it possible to produce a substantial number of boards in a limited amount of time. The production costs of such boards are considerably reduced.

Advantageously, the first facing of step a) makes it possible to considerably increase the flexural strength of the boards.

The invention also relates to the use of a board according to the invention characterised in that the board is used as an element under tiling, as a cladding element of building shells, as a roof underlay element or as an element of dry construction.

The cement boards according to the invention are also resistant to bad weather conditions and to saline mist. They are therefore particularly adapted to be used in the building sector, to form or cover walls, floors or roofs, on the inside or the outside of buildings, and in particular in very humid atmospheres or zones frequently-washed using water jets, for example industrial kitchens, food industry laboratories, showers or bathrooms, basins, swimming pools, farm buildings or industrial butcheries.

Such boards may also be used to form or cover walls, floors or roofs exposed to saline mist.

### BRIEF DESCRIPTION OF THE FIGURES

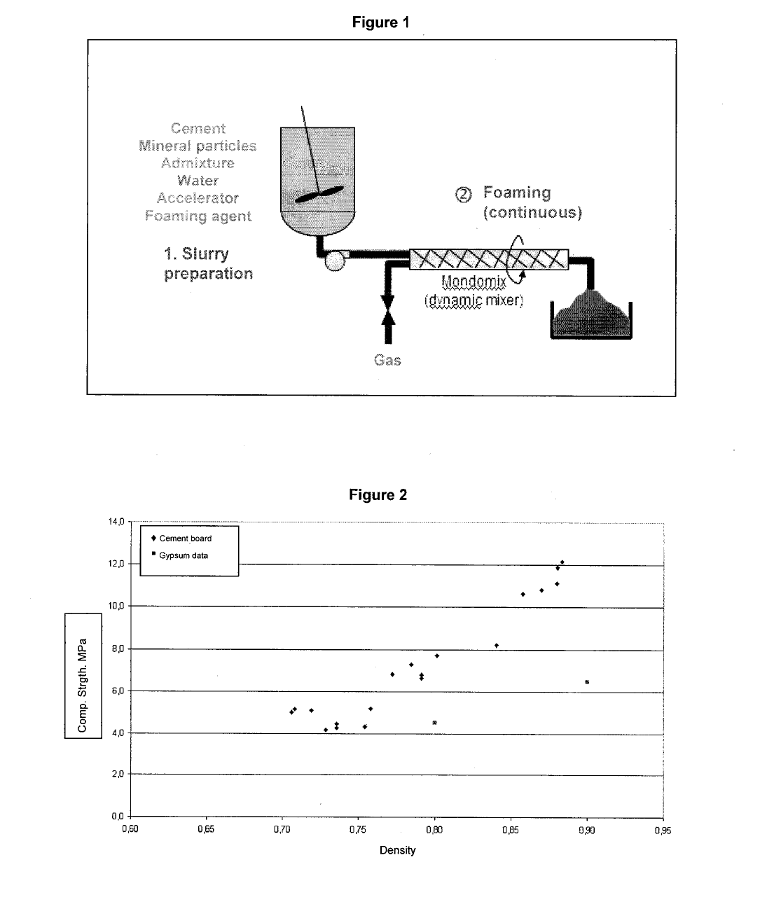

The following figures illustrate the invention without restricting its scope. FIG. 1 is a diagram of a variant of the process for production of a composition used to produce the body of the cement board according to the invention with direct introduction of air. FIG. 2 is a graph of the mechanical strengths of a cement board according to the invention compared with a known plaster board.

Referring first to FIG. 1, the process of production of a board according to the invention comprises the preparation of a slurry (1) comprising cement, mineral particles, admixtures, water, an accelerator (the calcium salt) and a foaming agent. The process comprises continuous foaming (2) with direct introduction of air in the dynamic Mondomix mixer.

The following examples illustrate the invention without restricting its scope.

### EXAMPLES

Materials:

Millifoam H: an anionic foaming agent (alkyl ether sodium sulphate) supplied by the Huntsman company;
Calcium chloride: pure anhydrous CaCl₂ from Verre Labo Mula;
The Portland cement is a CEM I 52.5 R cement from the Lafarge Port La Nouvelle cement plant (Batch No. LHY-3830 or LHY-3867);
The mineral particles are calcium carbonate supplied by the OMYA company under the brand name of Betocarb HP Entrains in which the D₅₀ is 7.8 μm, the D₁₀ is 1.7 μm, the D₉₀ is 93 μm and with a maximum particle size of 200 μm (Batch No. ADD-0239);
The fluidizer (plasticizer) is a mixture comprising a polycarboxylate polyoxide (PCP) supplied by the Chryso company under the brand name of Chrysolab EPB 530-170; it is based on Premia 180 but does not contain an anti-foaming agent;
The fly ash comes from North America (Lafarge, Will County, Ill.): particle size D₅₀=6.8 μm;
Superpozz is from South Africa: particle size D₅₀=3.4 μm; The pozzolans come from Greece (Yali).
Water: tap water.

In the description and the examples, the particle size and size distributions (between 0.02 μm and 2 mm) were measured using a Malvern MS2000 laser granulometer. The measurements were carried out in ethanol. The light source was a red He—Ne laser (632 nm) and a blue diode (466 nm). The optical model was that of Mie and the calculation matrix was of the polydisperse type. The apparatus was checked before each working session by means of standard samples (Sibelco France (formerly known as Sifraco) C10 silica) for which the particle size distribution was known. Measurements were carried out with the following parameters: pump speed 2300 rpm and stirrer speed 800 rpm. The sample was introduced in order to establish an obscuration between 10 and 20%. The measurement was carried out after stabilisation of the obscuration. Ultrasound at 80% was first applied for 1 minute to ensure the de-agglomeration of the sample. After 30 seconds (for possible air bubbles to clear), a measurement was carried out for 15 s (15000 analysed images). Without emptying the cell, the measurement was repeated at least twice to verify the stability of the result and elimination of possible bubbles. All values given in the description and the specified ranges correspond to average values obtained with ultrasound.

Production of Cement Boards According to the Invention:

The cement, the mineral particles and the calcium salt were weighed together on the scale. The mixing water and the fluidizer (Chrysolab) were then weighed separately. Likewise, the Millifoam was weighed separately. All the weighed powders were placed in the pan of the mixer (Rayneri™ MALX-104, Rayneri VMI, model PH602, serial no. 121025) and were stirred for one to two minutes using the mixer's rotating blade with a planetary motion (17 revolutions/minute). The mixing water comprising the fluidizer was added to the powders in the pan of the mixer (33 revolutions/minute for one to two minutes, depending on the volume). A cement slurry was thus obtained, which was stirred for two additional minutes in the mixer. The mixer was stopped. The pan of the mixer was scraped and the Millifoam was poured onto the surface of the cement slurry. Mixing was resumed to incorporate the Millifoam into the slurry (the speed varying from 17 to 25 revolutions/minute for approximately two minutes). Cement slurries were obtained and were ready to be foamed. Table 1 below presents the chemical compositions of the different cement slurries made according to the invention.

TABLE 1

| | Slurry formulations | | | | |
|---|---|---|---|---|---|
| | 1 | 2 | 3 | 4 | 5 |
| Millifoam H ⁽¹⁾ | 1.45 | 1.42 | 1.49 | 1.42 | 1.41 |
| CaCl₂ | 0.8 | 0.78 | 0.83 | 0.78 | 0.79 |
| CEM I 52.5 R Cement | 40.13 | 26.63 | 41.61 | 26.64 | 39.29 |
| CaCO₃ | 39.74 | 27.3 | 0 | 40.85 | 0 |
| Chrysolab | 0.16 | 0.13 | 0.16 | 0.13 | 0.16 |
| Water | 17.72 | 19.64 | 19.54 | 19.38 | 18.45 |
| Pozzolans | 0 | 0 | 0 | 10.8 | 0 |
| Superpozz | 0 | 24.1 | 36.37 | 0 | 0 |
| Fly Ash from Willcounty | 0 | 0 | 0 | 0 | 39.9 |
| Ratio of Millifoam/CaCl₂ | 0.49 | 0.49 | 0.48 | 0.49 | 0.48 |

Amounts in Table 1 are given in % by mass relative to the total mass of the formulation.
⁽¹⁾ The amount of Millifoam is the amount of commercial product containing 27% of active material. The ratio of Millifoam to CaCl₂ given in the Table 1 is of active material to CaCl₂.

The production of the foamed cement slurry was carried out continuously. The cement slurry, previously obtained, was poured into a buffer vessel stirred using a Rayneri Turbotest mixer (MEXP-101, Rayneri VMI, model Turbotest 33/300, series n° 71815) comprising a de-flocculating blade (the speed of the blade varying from 1000 rpm to 400 rpm depending on the volume of slurry). The slurry was pumped using a volumetric pump of the Moineau type (Seepex™ MEXP-413 ecccentric screw pump, model BN-025-12, series n° 243327) at a flow of approximately 1 Litre/minute. The slurry was then introduced into a foamer (Mondomix™ MALX-160, Minimondo A05, series n° P14018-37115) to which compressed air was added (generated by a Brooks air regulator, series n° T55329/028) at a flow of 2.75 Litres/minute. The flow was adapted to the desired density of foam at the outlet of the foamer, generally from 1 to 4 Litres/minute. The rotation speed of the foamer was 400 rpm, however, the rotation speed was adapted to the desired density of the foam at the outlet of the foamer and could vary from 250 to 1500 rpm. A static helicoidal mixer (Isojet™) was present at the outlet of the foamer. A foam was thus obtained, it was a foamed cement according to the invention.

Production of the Boards

A mould was prepared by vertical assembly of two boards, 40×60 cm in size, on which two facings were placed and spaced at 13 mm. The facing was a non-woven facing of glass fibres. The previously obtained foamed cement according to the invention was introduced into the mould. The obtained boards were demoulded after three hours. These boards were placed for 24 hours in an atmosphere at 100% hygrometry and at 20° C. At the end of this treatment they were dried and kept in a drying oven at 45° C.

Compressive Mechanical Strengths

Two cement boards were produced (N° 1 and N° 2) from the formulation of cement slurry n° 1. These boards were cut into 5×5 cm samples and 13 mm thickness. The density was measured for each piece of board.

The mechanical strength was tested. Each board sample was submitted to compressive mechanical stress until breaking of the sample using a Zwick™ press (PRES-0018-1997/03). In this way the value of the maximum force exerted on the surface of the sample was measured. A compressive strength was then deduced. The measurements were carried out in a stabilised temperature environment (23° C.) and 50% relative humidity. The obtained results are given in Table 2 and in FIG. 2.

TABLE 2

| | Specific | Mechanical |
|---|---|---|
| | gravity | strength in MPa |
| Comparison example: plaster board | 0.8 | 4.5 |
| (standard BA13) | 0.9 | 6.5 |
| Cement board (top of board N°1) average | 0.86 | 10.8 |
| value for 6 samples | | |
| Cement board (bottom of board N°1) average | 0.77 | 6.8 |
| value for 6 samples | | |
| Cement board (middle of board N°2) average | 0.73 | 4.6 |
| value for 7 samples | | |

1. A cement board having a density from 200 to 1000 kg/m³, the cement board produced from a foamed cement slurry comprising:
cement;
water;
from 0.01 to 5% of a water-reducing agent, a plasticizer or a superplasticizer, % by mass relative to the mass of cement;
from 0.45 to 5%, of a foaming agent, % by mass relative to the mass of water;
a water-soluble calcium salt;
mineral particles from 0.1 to 300 μm in size;
a ratio of foaming agent to calcium salt being from 0.3 to 0.8.

2. The board according to claim 1, comprising an alkyl sulphate or an alkyl ether sulphate with linear or branched carbon chains of formula (I)
CₙH₂ₙ₊₁—(OCH₂CH₂)ₘ—OSO₃M (I)
in which n is from 8 to 14 and m is from 0 to 15, M being an alkali metal cation.

3. The board according to claim 1, comprising a linear or branched alkyl ether sulphate of formula CₙH₂ₙ₊₁—(OCH₂CH₂)ₘ—OSO₃M in which n is from 8 to 12 and m is from 1 to 6.

4. The board according to claim 1, comprising a mixture of alkyl ether sulphate and alkyl sulphate.

5. The board according to claim 1, wherein the water-soluble calcium salt is selected from calcium chloride, calcium nitrite and calcium nitrate.

6. The board according to claim 1, further comprising at least one facing.

7. The board according to claim 6, further comprising at least one linking layer between the facing and the body of the board.

8. A process for production of a board according to claim 1, the process comprising
of putting into contact at least
cement;
water;
from 0.01 to 5% of a water-reducing agent, a plasticizer or a superplasticizer, % by mass relative to the mass of cement;
from 0.45 to 5% of a foaming agent, % by mass relative to the mass of water;
a water-soluble calcium salt;
mineral particles from 0.1 to 300 μm in size;
a ratio of foaming agent to calcium salt being from 0.3 to 0.8;
introducing gas or foam; and
forming the board.

9. The process of production according to claim 8, further comprising supplying at least one facing.

10. A method comprising using a board according to claim 1 as an element under tiling, as a cladding element of building shells, as a roof underlay element or as an element of dry construction.
